(19) United States
(12) Patent Application Publication
(10) Pub. No.: US 2009/0033516 A1
(43) Pub. Date: Feb. 5, 2009

(54) INSTRUMENTED WELLBORE TOOLS AND METHODS

(75) Inventors: Laurent Alteirac, Paris (FR); Axel Destremau, Houston, TX (US)

Correspondence Address: SCHLUMBERGER RESERVOIR COMPLETIONS, 14910 AIRLINE ROAD, ROSHARON, TX, 77583, US

(73) Assignee: SCHLUMBERGER TECHNOLOGY CORPORATION, Sugar Land, TX (US)

(21) Appl. No.: 11/833,081

(22) Filed: Aug. 2, 2007

(51) Int. Cl. G01V 3/18

(52) U.S. Cl. 340/853.2; 340/853.3

(57) ABSTRACT

A method for monitoring an operation conducted in a well in accordance with the present invention includes running a service tool into the well; delivering a material through the service tool; obtaining data using a plurality of sensors carried by the service tool; communicating the data to a local electronic hub; transmitting the data from the local electronic hub to a surface processor; and displaying the wellbore data on the surface processor.

### FIELD OF THE INVENTION

The present invention relates in general to wellbore operations and more specifically to equipment and methods for real time monitoring and control of wellbore operations.

### BACKGROUND

There is a continuing need to improve the efficiency of hydrocarbon production and of wellbore operations. It is a desire of the present invention to provide tools and method for monitoring and conducting wellbore operations.

### SUMMARY OF THE INVENTION

In view of the foregoing and other considerations, the present invention relates to real time monitoring and control of wellbore operations.

In an aspect of the present invention, a method for monitoring an operation conducted in a well in accordance with the present invention includes running a service tool into the well; delivering a material through the service tool; obtaining data using a plurality of sensors carried by the service tool; communicating the data to a local electronic hub; transmitting the data from the local electronic hub to a surface processor; and displaying the wellbore data on the surface processor.

In one aspect of the present invention, an instrumented wellbore tool includes one or more operation elements, a plurality of micro-electro mechanical systems (MEMS), and a local electronic hub for communicating data between the MEMS and a surface processor.

The foregoing has outlined the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

The foregoing and other features and aspects of the present invention will be best understood with reference to the following detailed description of a specific embodiment of the invention, when read in conjunction with the accompanying drawings, wherein:

FIGS. 1A-1D illustrate the performance of a gravel pack completion for sand control in a well;

FIG. 2 is a view of an instrumented service tool of the present invention in isolation; and

FIG. 3 is illustrates telemetry network of the present invention

### DETAILED DESCRIPTION

Refer now to the drawings wherein depicted elements are not necessarily shown to scale and wherein like or similar elements are designated by the same reference numeral through the several views.

As used herein, the terms “up” and “down”; “upper” and “lower”; and other like terms indicating relative positions to a given point or element are utilized to more clearly describe some elements of the embodiments of the invention. Commonly, these terms relate to a reference point as the surface from which drilling operations are initiated as being the top point and the total depth of the well being the lowest point.

One aspect of the present invention is the use of a plurality of sensors, such as micro-electro-mechanical systems (MEMS) devices, to monitor operations in a well, such as gravel packing and fluid production. Other aspects of the present invention include utilization of MEMS devices as actuators for conducting operations in a well and the communication of data between the surface and the downhole sensors and actuators.

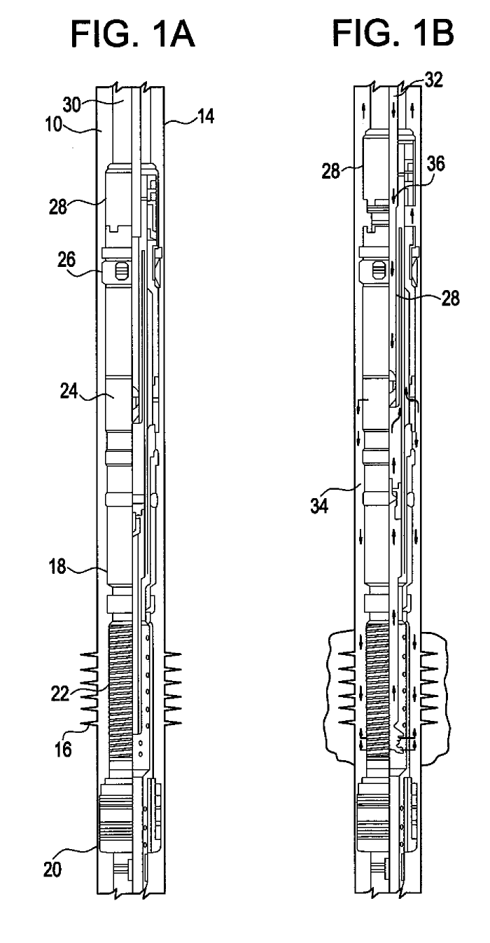

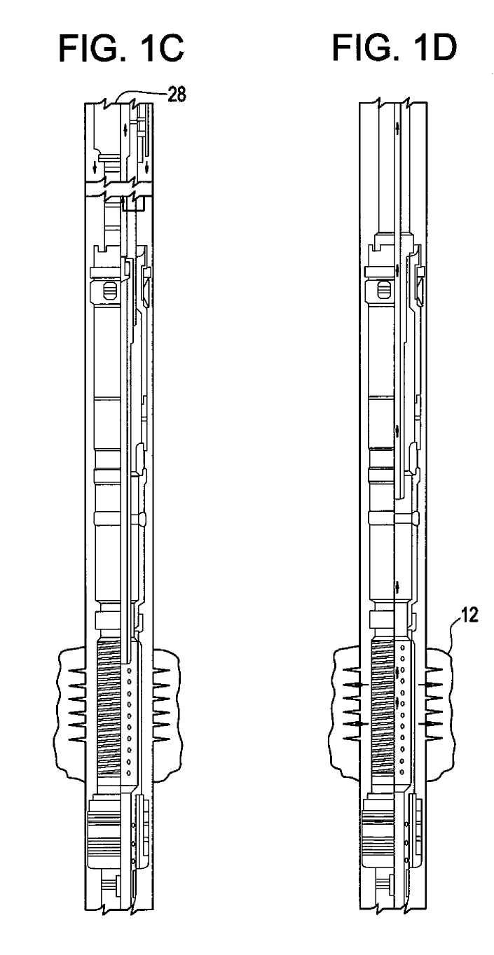

FIG. 1A through 1D illustrate a gravel pack operation being conducted in wellbore 10. Wellbore 10 penetrates into production formation 12. Well 10 includes a casing 14 that has a plurality of perforations 16 that allow fluid communication between well 10 and formation 12. A wellbore tool 18, such as a sand control completion, is positioned within the well adjacent to formation 12, which is to be gravel packed. Wellbore tool 18 generally includes sump packer 20, sand screen 22, operation elements 24 such as cross-over valves and the like, and a production or gravel pack packer 26. A service tool 28 is connected to wellbore tool 18 and operation elements 24 for operation of wellbore tool 18 to conduct wellbore operations. Service tool 28 is carried by tubing 30. Tubing 30 and wellbore tool 18, including service tool 28, have an internal bore 32. An annulus or annular region 34 is located between the wall of wall 10 and the exterior of tubular 30 and wellbore tool 18.

It is noted that the present invention may be utilized in both cased wells and open hole completions. Tubing 30 can also be referred to as a tubular member, tubing string, service string, work string or other terms well known in the art. As is well known in the art wellbore tool 18 can be configured in various manners and include different operation elements for the particular wellbore operation and well configuration.

Wellbore tool 18 is shown in the running in the hole (RIH) position in FIG. 1A. Packer 26 is set, and tested to ensure that a seal between the tubular member 30 and casing 14 has been formed. Referring to FIG. 1B, service tool 28 is operated to open cross-over valve 24 for circulating gravel. Gravel laden slurry 36 is then pumped down internal bore 32, exits tubular member 30 through cross-over valve 24 positioned below packer 26 and enters annulus 34. The carrier fluid leaves slurry 36 at perforations 16 and screen 22. A portion of the residual carrier fluid re-enters the internal bore and is carried above packer 26 and routed back to annulus 34 and to the surface. As shown in FIG. 1C, service tool 28 may be further actuated to reverse out excess gravel. After completion of the gravel pack operation, service tool 28 may be removed and production tubing is installed.

The present invention may employ any type of service tool 28 and tubular 30, referred to in combination as the service tool string 38, including the service tool for gravel packing and fracture packing applications illustrated herein. For example, service tool 28 may be of the type that is operated or actuated by movement relative to the upper packer 26, such as illustrated in FIGS. 1A through 1D wherein the gravel pack operation is performed by manipulating service tool 28 to provide for the various pumping positions/operations (e.g., circulating position, squeeze position, and reversing position) and pumping the gravel slurry. It is also noted, pursuant to the teachings herein, that movement of service tool 28 relative to packer 26 may not be necessary for conducting operations utilizing aspects of the present invention.

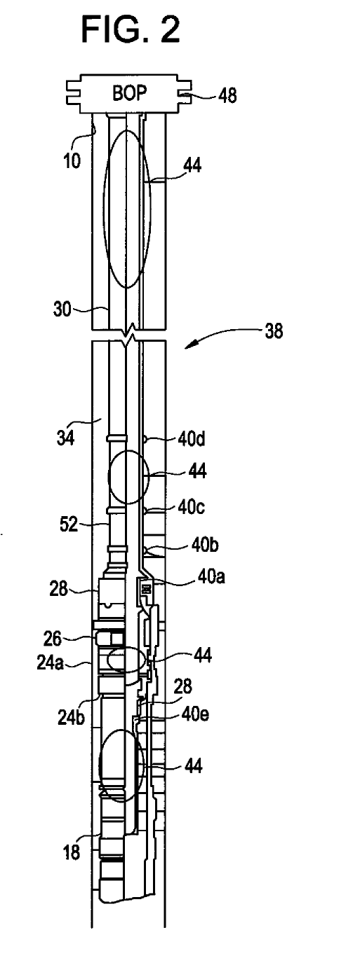

Referring now to FIG. 2 an illustration of an instrumented service tool 28 is provided in isolation. The illustrated service tool 28 is mechanically interlocked with packer 26 to allow the bottomhole assembly to function as a single unit. In this illustration service tool 28 includes operation devices such as a modular crossover port (valve) 24a, packer 26, and a floater module 24b. As described and illustrated with reference to FIGS. 1A through 1D, service tool 28 is incorporated into wellbore tool 18 during operations. A plurality of micro-electro mechanical systems (MEMS) 40, are positioned along service tool 28. MEMS 40 may include telemetry elements, such as sensors, as well as actuators or triggers. Service tool 28 may include other operation elements and blank tubulars as desired for the particular operation.

MEMS embody the integration of mechanical elements, sensors, actuators, and electronics on a common substrate. For example, a MEMS pressure sensor may include components to detect the surrounding pressure or data associated with the pressure, as well as a bi-directional radio, optical communication mechanism, microprocessor, and energy source such as a battery or optical cell. MEMS sensors allow for detecting a characteristic of the wellbore, service tool, or wellbore tool and to transmit that data a relatively short distance. MEMS may include relatively simple analog and/or digital circuitry such as to identify on or more inputs and to control one or more outputs accordingly.

It should be noted that the MEMS 40 may be one of numerous types of gauges, sensors and actuators. For example, the present invention may use pressure sensors, temperature sensors, flow rate measurement devices, oil/water/gas ratio measurement devices, scale detectors, equipment sensors (e.g., vibration sensors, position sensors), sand detection sensors, water detection sensors, viscosity sensors, density sensors, bubble point sensors, pH meters, multiphase flow meters, acoustic detectors, solid detectors, composition sensors, resistivity array devices and sensors, acoustic devices and sensors, other telemetry devices, near infrared sensors, gamma ray detectors, H2S detectors, CO2 detectors, downhole memory units, downhole controllers, locators, strain gauges, pressure transducers, and the like.

Examples of MEMS 40 include, a pressure sensor 40a positioned to detect the pressure and or data associated with the pressure in bore 32 proximate to service tool 28. Pressure sensor 40b positioned to detect the pressure and or data associated with the pressure in annulus 34 proximate to service tool 28. Sensor 40c is a MEMS strain gauge position proximate to the head of service tool 28 to detect and measure the axial tensile load on tubing 30 at the level of service tool 28. Sensor 40d is a flow rate sensor positioned to detect the flow rate in annulus 34 above packer 26, such as to monitor the flow rate of the returns. Sensor 40e is a flow rate sensor for detecting the flow rate in the tubing proximate valve 24a. The present invention may further include sensors to detect and/or measure for example the flow rate in the annulus and tubing, pressure and temperature at key locations, and sensors to detect the position of various operational devices 24.

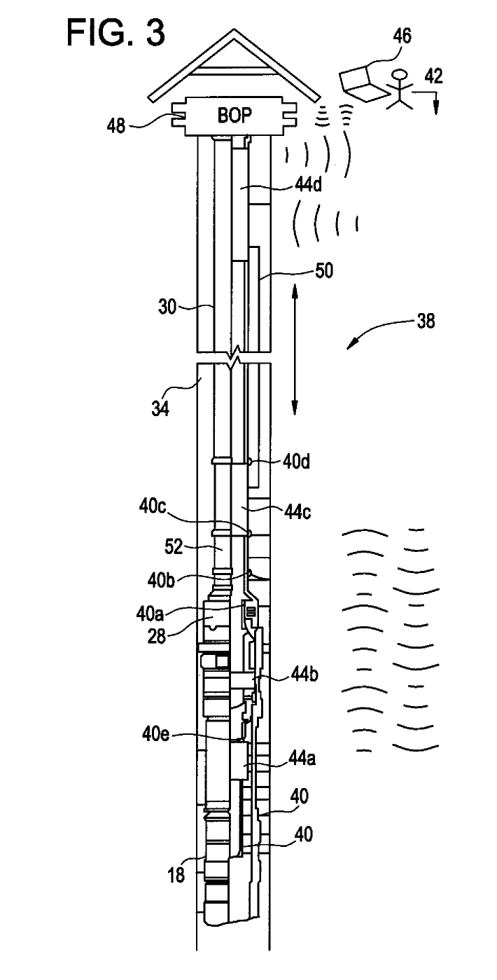

Referring now to FIG. 3, communication of the data obtained by sensors 40 to the surface 42 is described. In the illustrated aspect of the present invention, the data obtained by the sensors 40 is transmitted by wireless telemetry to a local electronic hub 44 for further transmission to the surface and to a surface processor 46.

Local electronic hubs 44 are provided due to the short range communication capability of MEMS 40. Thus, electronic hubs 44 include a power source and communication mechanism (not shown) for receiving data from sensors 40 and transmitting to other hubs 44 and or surface processor 46. Electronic hubs 44 may further include processors and electronic storage mechanisms. For example, electronic hubs 44 may be an independently powered, stand-alone, two-way wireless communication device for receiving data from sensors 40 and transmitting to surface processor 46 and/or for communicating data and commands from surface processor 46 to sensors 44 or other MEMS devices.

Surface processor 46, as well as other microprocessors of the present invention, may include a central processing unit, such as a conventional microprocessor, and a number of other units interconnected via a system bus. The data processing system may include a random access memory (RAM) and/or a read only memory (ROM) and may include flash memory. Data processing system may also include an I/O adapter for connecting peripheral devices such as disk units and tape drives to a bus, a user interface adapter for connecting a keyboard, a mouse and/or other user interface devices such as a touch screen device to the bus, a communication adapter for connecting the data processing system to a data processing network, and a display adapter for connecting the bus to a display device which may include sound. The CPU may include other circuitry not shown herein, which will include circuitry found within a microprocessor, e.g., an execution unit, a bus interface unit, an arithmetic logic unit (ALU), etc. The CPU may also reside on a single integrated circuit (IC).

An example of operation of an instrumented service tool is now described with reference to FIGS. 1 through 3. Wellbore data as well as tool data is detected by the various sensors and sent to a communication hub 44. For example, wellbore pressure data in the tubing and annulus proximate the service tool is obtained by sensors 40a and 40b and transmitted to hub 44b by wireless telemetry such as radio frequency. The data may then be transmitted up the well to hub 44c. From hub 44c the data may be transmitted to a hub 44d positioned proximate to the blowout preventer (BOP) 48 or directly to surface processor 46. A hub 44d is specifically identified proximate to and below BOP 48 due to communication interruptions that may be experienced at this location. It is noted that BOP 48 may be positioned at rig level, land or marine, and/or subsea or subsurface. The data may then be conveyed between hub 44d and surface processor 46. In another example, flow rate data obtained at sensor 40e may be transmitted to hub 44a and then transmitted to surface processor 46 including as many intermediate hubs 44 as necessary.

Communication of data between the hub 44 and surface processor 46 have been described as being wireless. However, other means of transmitting and conveying the data may be utilized. For example, control lines, such as control line 50 (FIG. 3) between hubs 44c and 44d, may be utilized. Control lines include without limitation cables and optical fibers. Additionally, pressure pulse telemetry may be utilized.

Data from sensors 40 may be continuously received by processor 46 and displayed and monitored in real time. In response to the data, various steps in the operational process may be terminated, adjusted or initiated including actuating service tool 28. The physical manipulations in the downhole tool may be initiated physically from the surface or via electronic signals received by the various sensors/actuators 40 positioned downhole.

In another aspect of the present invention, a strain gauge is utilized to transmit data and/or command between surface processor 46 and the downhole tools. For example, MEMS strain gauge 40c is positioned proximate to service tool 28 head. An operator may transmit a control signal via tubing 30 to MEMS device 40c to operate service tool 28. In this aspect, strain gauge 40c detects the tension in tubing 30 (load) and reacts pursuant to predetermined instructions. For example, commonly service tool 28 may include a chamber containing a fluid such as nitrogen under pressure for operating various pistons and valves. In the configuration illustrated in FIG. 3, this activation chamber, its contained material and the associated elements are represented by motivation device 52. MEMS device 40c, generally referred to as a sensor, may send a signal directly to motivation device 52 for actuation of service tool 28. In an example, motivation device 52 may include an activation material such as a contractable polymer, or other material generally known as “artificial muscle”, for operation of the tools in response to the signals.

Examples of data obtained by MEMS devices 40 for monitoring include, without limitation, pressure on the tubing side and the annulus at the depth of the service tool 28; pressure in the annulus below packer 26; pressures above and below the ball valve; temperature at the level of the service tool; flow rates at the service tool, ball valve, and above the packer; position of the service tool in relation to packer 26 and in relation to the BOP; tubing and annulus pressure below the BOP; and the load in the tubing string at the service tool. MEMS Devices 40 may further be utilized as actuators such as for the operation of the various valves that may be including in the service tool string.

From the foregoing detailed description of specific embodiments of the invention, it should be apparent that an instrumented wellbore tool and method for real time monitoring and control of operations in a wellbore that is novel has been disclosed. Although specific embodiments of the invention have been disclosed herein in some detail, this has been done solely for the purposes of describing various features and aspects of the invention, and is not intended to be limiting with respect to the scope of the invention. It is contemplated that various substitutions, alterations, and/or modifications, including but not limited to those implementation variations which may have been suggested herein, may be made to the disclosed embodiments without departing from the spirit and scope of the invention as defined by the appended claims which follow.

What is claimed is:

1. An instrumented wellbore tool, the tool including:
one or more operation elements;
a plurality of micro-electro mechanical systems (MEMS); and
a local electronic hub for communicating data between the MEMS and a surface processor.

2. The tool of claim 1, wherein the plurality of MEMS include sensors for obtaining data associated with conditions of the wellbore in which the tool is positioned.

3. The tool of claim 1, wherein the plurality of MEMS include actuators for operating the operation elements.

4. The tool of claim 1, wherein the plurality of MEMS includes sensors for obtaining data associated with the operation elements.

5. The tool of claim 1, further including a tubular string connected to the tool, the tubular string carrying at least one electronic hub in communication with the local electronic hub.

6. The tool of claim 5, wherein the plurality of MEMS include sensors for obtaining data associated with conditions of the wellbore in which the tool is positioned.

7. The tool of claim 5, wherein the plurality of MEMS include actuators for operating the operation elements.

8. The tool of claim 6, wherein the plurality of MEMS include actuators for operating the operation elements.

9. The tool of claim 5, wherein the plurality of MEMS include sensors for obtaining data and at least one actuator for operation at least one operation element.

10. A method for monitoring an operation conducted in a well, the method comprising the steps of:
running a service tool into the well;
delivering a material through the service tool;
obtaining data using a plurality of sensors carried by the service tool;
communicating the data to a local electronic hub;
transmitting the data from the local electronic hub to a surface processor; and
displaying the wellbore data on the surface processor.

11. The method of claim 10, wherein the sensors are micro-electro mechanical system (MEMS).

12. The method of claim 10, wherein the data includes data associated with conditions in the wellbore.

13. The method of claim 10, wherein the data includes data associated with the service tool.

14. The method of claim 12, wherein the sensors are MEMS.

15. The method of claim 13, wherein the sensors are MEMS.

16. The method 10, further including the steps of:
communicating a command from the surface processor to the service tool; and
manipulation of an operation element of the service tool in response to the received command.

17. The method of claim 16, wherein the command is received at the service tool by a MEMS in functional connection with the operation element.

18. The method of claim 17, wherein the operation element includes a contrastable polymer for manipulating the operation element.

19. A method of conducting a gravel pack operation in a wellbore, the method comprising the step of:
providing a service tool having an operation element and a plurality of MEMS sensors;
running the service tool into the wellbore;
delivering a gravel slurry through the service tool;
obtaining data associated with the conditions of the wellbore and conditions of the service tool;
communicating the data to a local electronic hub;
transmitting the data from the local electronic hub to a surface processor; and
displaying the wellbore data on the surface processor.

20. The method of claim 19, further including the step of transmitting a command from the surface via the local electronic hub to a MEMS device in connection with a contractable polymer causing the operation element to move from a first position to a second position.
